(19) United States
(12) Patent Application Publication
(10) Pub. No.: US 2024/0048610 A1
(43) Pub. Date: Feb. 8, 2024

(54) DISCONNECTION OF MESSAGE BROKER CONSUMER GROUPS OF PRIOR APPLICATION VERSIONS

(71) Applicant: SAP SE, Walldorf (DE)

(72) Inventor: Anbusivam S, Bangalore (IN)

(21) Appl. No.: 17/880,034

(22) Filed: Aug. 3, 2022

(51) Int. Cl. H04L 67/10; G06F 16/21

(52) U.S. Cl. CPC H04L 67/10; G06F 16/219

(57) ABSTRACT

A specialized topic in a message broker that is devoted to infrastructure messages is used. This infrastructure topic is then subscribed to by various applications, such as application microservices, including instances of applications running on different versions of the same application. Subscribing message consumers can then write a message to the infrastructure topic, with the message including the application identification and version number. Other message consumers subscribed to the infrastructure topic will receive notifications of this posted message. When a message consumer receives such a message, it checks to see if the message comes from an application that has the same application identification as itself. Then it checks to see if the version number included in the message is greater than its own version number. If so, then the application version of the recipient message consumer has been superseded and the application disconnects itself from the message broker.

### TECHNICAL FIELD

This document generally relates to message brokers. More specifically, this document relates to disconnection of message broker consumer groups of prior application versions.

### BACKGROUND

A message broker is software that enables applications, systems, and services to communicate with each other and exchange information. Message brokers can be used for asynchronous communication using a publish/subscribe model. In this message distribution pattern, the source of each message publishes the message to a topic at the message broker, and multiple message consumers subscribe to topics from which they want to receive messages. All messages published to a topic are distributed to all the applications subscribed to it.

Microservices are small, independent software processes that can be written in multiple languages. An infrastructure designed for these modular components is known as a microservices environment or microservices architecture. Cloud environments may be used to implement microservices environments. An example of a microservices environment is SAP Cloud Platform® Extension Manager, from SAP SE of Walldorf, Germany. Microservices can use a message broker for communications among themselves as well as to and from other applications.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system of disconnection of message broker consumer groups of prior application versions, in accordance with an example embodiment.

FIG. 2 is a flow diagram illustrating a method of disconnection of message broker consumer groups of prior application versions, in accordance with an example embodiment.

FIG. 3 is a block diagram illustrating an architecture of software, which can be installed on any one or more of the devices described above.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

One issue that arises with message brokers, and especially with microservices subscribed to topics in message brokers, is that an individual microservice (which is an application) may get overwhelmed with incoming messages that have been posted to a subscribed topic. This is especially true as a microservices architecture is scaled: as the number of microservices in an architecture increases, the number of messages sent in that architecture increases exponentially. The result is that an individual microservice that is subscribed to a topic may receive more messages than it is able to process during a given time period, causing delays in processing and/or the dropping of messages.

One solution is to use topic partitioning. Here, a message broker divides a topic into multiple partitions, with each partition only holding a subset of all the messages handled by the topic. The partitions are all essentially listed to the same topic, but each only takes one subsection of the messages posted to that topic. A group of message consumers (such as microservices), called a consumer group, can then be established, each of which is assigned to a different partition (in some instances a consumer in the consumer group can be assigned to multiple partitions, but no partitions are assigned to more than one consumer in the same consumer group). It is possible to have more than one consumer group for the same topic where each consumer group receives copy of all the messages from the topic. Here, for example, an application that will consume messages can be divided up into multiple redundant microservices, and each of those redundant microservices may be added to a specific consumer group. Thus, each of the consuming microservices in the consumer group receives and processes only a subset of the messages for that topic. There can then be additional coordination among the consuming microservices in the consumer group to synchronize the results of their independent processing, such as by storing output data in a repository shared among the consuming microservice in the consumer group.

Another technical issue that arises, however, is that the applications themselves may be occasionally upgraded or otherwise modified, such as to add enhancements or bug fixes. In such a case, a new consumer group is created part of the upgraded application for an existing consumer group. The problem is that there is then a delay in when the new consumer group can begin to receive and process messages from the topic in the message broker. This is because the message broker has fully assigned all the partitions in the topic to one or more consumers (e.g., microservices) in the consumer group of the old version of the application, and thus the message broker will need to wait until each of those consumers in the consumer group in the old version of the application has disconnected before reassigning the partition(s) to the new consumers in the consumer group.

This delay can cause problems in the architecture. At the very least, whatever improvement or bug fix the new version of the application implements will not get to be fully utilized until the message broker starts assigning consumers in the consumer group associated with the new version to the partitions of the topic. It also leads to a situation where either the exact time the functioning of the old version of the application will be completely passed over to the functioning of the new version of the application microservices is unpredictable, or some preplanned disconnection of the consumers in the consumer group of the old version of the application needs to be scheduled.

In an example embodiment, this technical issue is overcome by introducing a specialized topic in the message broker that is devoted to infrastructure messages. This infrastructure topic is then subscribed to by various applications, such as application microservices, including instances of applications running on different versions of the same application. Subscribing message consumers can then write a message to the infrastructure topic, with the message including the application identification and version number. This message posting to the infrastructure topic can occur, for example, when an application is deployed, or on restart of the application. Other message consumers subscribed to the infrastructure topic will receive notifications of this posted message. When a message consumer receives such a message, it checks to see if the message comes from an application that has the same application identification as itself. Then it checks to see if the version number included in the message is greater than its own version number. If so, then the application version of the recipient message consumer has been superseded and the application disconnects itself from the message broker.

In some example embodiments, if the recipient message consumer determines that the application identification in the message matches its own application identification but the application version in the message is not greater than its own application version, then this means that the recipient message consumer is running the latest version of the application and it publishes a message to the infrastructure topic with its own application name and its own version, so that other message consumers with applications older than this version can disconnect themselves.

The size of a consumer group for a topic may also be limited to the number of partitions for the topic. In other words, the number of message consumers in the consumer group may be restricted so as to never exceed the number of partitions for the topic. Any new assignment of a message consumer to a consumer group that is already full (already has a number of message consumers equal to the number of partitions for the topic) will need to wait until one of the existing message consumers in the consumer group goes idle.

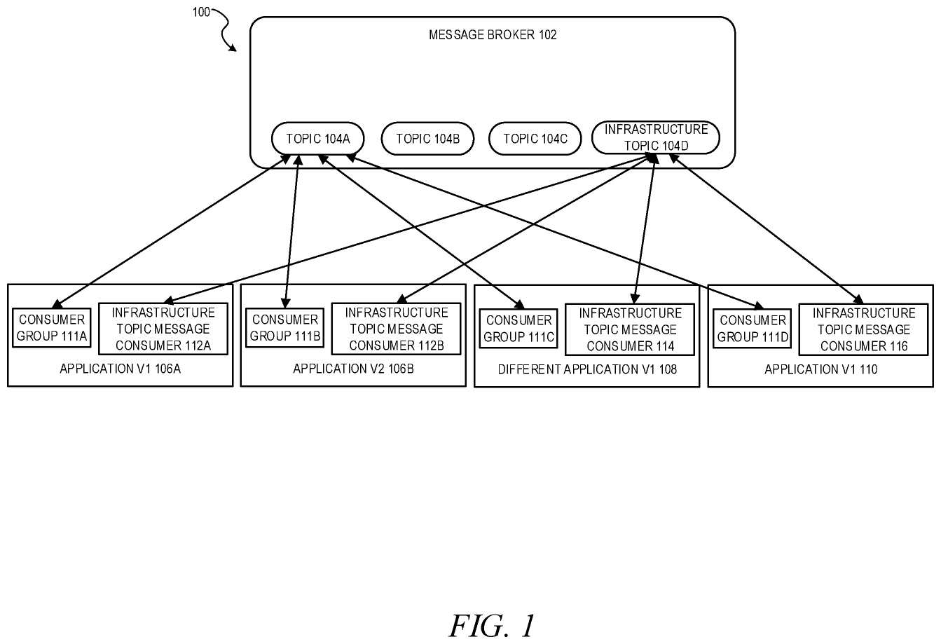

FIG. 1 is a block diagram illustrating a system 100 of message broker consumer groups of prior application versions, in accordance with an example embodiment. Here, a message broker 102 may maintain a number of topics 104A-104C, with one or more of these topics 104A-104C being divided into multiple partitions (not pictured). One example of a message broker 102 is Kafka™ from the Apache Software Foundation of Wilmington, Delaware. Various applications 106A, 108, 110 subscribe to one or more of the topics 104A-104C. Here, applications 106A, 108, and 110 subscribe to topic 104A. Each of these applications 106A, 108, 110 may have an associated consumer group 111A-111D.

An additional topic, called an infrastructure topic 104D, is also maintained in the message broker 102. The purpose of the infrastructure topic 104D is to receive and send messages regarding application versions.

When a new version of application 106A is deployed, which is depicted as application 106B, it is assigned a new application version number (incremented from the version number associated with application 106A. It should be noted that each application 106A, 106B, 108, 110 depicted here may, in fact, be an instance of an application, depending upon the nomenclature used. Thus, for example, application 106B may be considered to be an application instance of the same application (albeit a different version of the application) as the application instance depicted as application 106B.

The assignment of the new application number to the application upon creation and deployment of an upgrade or patch may be performed, for example, by an application developer. Embodiments are possible, however, where the assignment of the new application number is performed by an entity or component other than the application developer.

Each application 106A, 106B, 108, 110 is designed to generate a message to the infrastructure topic 104D at certain times, and also designed to read and handle messages from the infrastructure topic 104D. These messages are posted via a corresponding infrastructure topic message consumer 112A, 112B, 114, 116 that has subscribed to the infrastructure topic 104D.

If an application 106A, 106B, 108, 110 determines that all versions of the same application in messages from the infrastructure topic 104D are older than its own version (e.g., a version number less than its own), then it knows that its own version is the newest version of the application. As such, it publishes a message to the infrastructure topic 104D, the message including its application name and the application version number, so that the other applications 106A, 106B, 108, 110 can determine if they have outdated versions of the same application and can disconnect themselves, which would allow the newer version of the message to be able to start consuming messages from the subscribed topic(s) 104A, 104B, 104C. In the example depicted in FIG. 1, this means that application 106B, upon determining that there is a message from application 106A on the infrastructure topic 104D and determining that application 106A's version number is less than application 106B's version number, will publish a message to the infrastructure topic 104D with an identification of its own application and version number, which will then, as will be described below, prompt application 106A to disconnect message consumers in application 106A's consumer group 111A from the subscribed topic 104A, thus allowing application 106B's consumer group 111B (message consumers to be assigned to partitions of the subscribed topic 104A and to begin receiving messages from subscribed topic 104A. As such, once it publishes the message to the infrastructure topic 104D, the application 106B will begin listening to subscribed topic 104A so that as soon as partitions of the subscribed topic 104A are not listened to by application 106A (i.e., become idle), those partitions can be assigned to message consumers in application 106B's consumer group 111B. It should be noted that even though consumer group 111A and consumer group 111B are given different reference numerals in this figure, they may be identical to each other.

In the case where all the messages from identical applications are from applications having the exact same version, then the applications can simply listen to the subscribed topic 104A with all the other deployed applications. Thus, if hypothetically in this figure application 106A and application 106B were the same version of the same application, then both application 106A and 106B could listen to the subscribed topic 104A without either application 106A, 106B needing to disconnect.

The timing of when messages are posted to or processed from the infrastructure topic 104D can vary based on implementation. In an example embodiment, when an application 106A, 106B, 108, 110 is deployed, starts up, or is restarted, it creates a consumer for the infrastructure topic 104D, using its own consumer group identification, and consumes the infrastructure topic 104D until it is disconnected. After reading all messages from the infrastructure topic, it follows the same logic to listen, disconnect, and/or send a message and listen as described above.

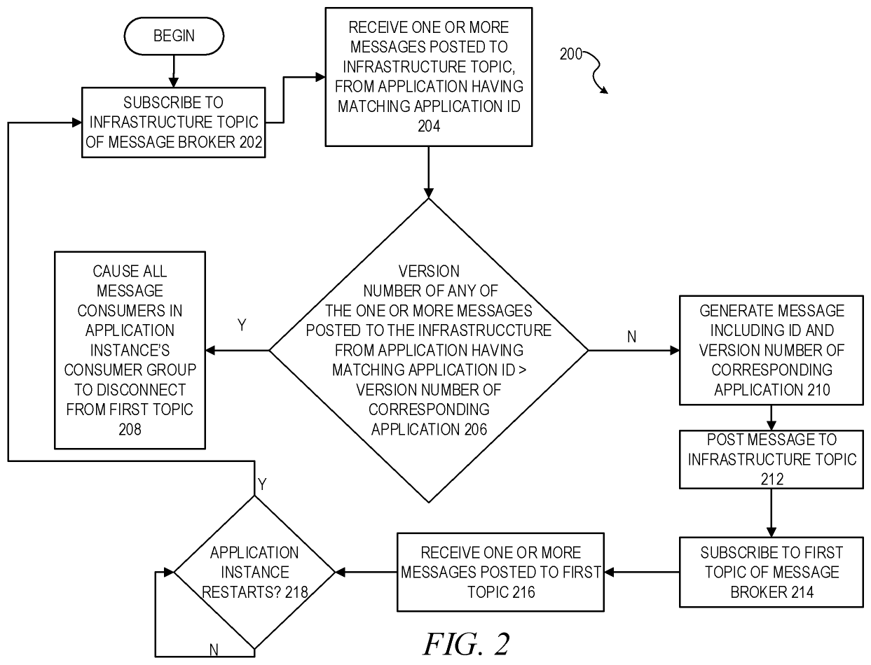

FIG. 2 is a flow diagram illustrating a method 200 of disconnection of message broker consumer groups of prior application versions, in accordance with an example embodiment. The method 200 may be performed by an application instance of any of the applications 106A, 106B, 108, 110 of FIG. 1. At operation 202, the application instance subscribes to an infrastructure topic of the message broker.

At operation 204, the application instance receives one or more message from the infrastructure topic that includes an application identification that matches the application identification of the corresponding application of the application instance. The message(s) also includes a version number. It should be noted that in an example embodiment, all messages posted to the infrastructure topic are received by the application instance.

At operation 206, the application instance determines if the version number from the message from the infrastructure topic is greater than the version number of the corresponding application of the application instance.

If so, then at operation 208, the application instance causes all message consumers in the application instance's consumer group to disconnect from the first topic. This means that all message consumers in the application instance's consumer group request that the message broker un-assign them from any assigned partitions of the first topic.

The message broker may have assigned the message consumers in the application instance's consumer group to one or more partitions of the first topic using a partitioning scheme. There are a number of different ways to implement partitioning logic. One example is rangeassignor, which aims to co-localize partitions of several topics by putting all consumers in lexicographic order of member identification and then putting available topic partitions in numeric order. The first partition in the list in each topic is then assigned to the first consumer in the list. Another example is round robin, which distributes available partitions evenly across all consumers. Another example is a sticky assignor, which is similar to round robin except it attempts to minimize partition movements between two assignments, all while ensuring a uniform distribution. Another example is streams partition assignor, which is used to assign partitions across application instances while ensuring their co-location and maintaining states for active and standby tasks.

If it is determined that the version number from the message from the infrastructure topic is not greater than the version number of the corresponding application of the application instance, then at operation 210, the application instance generates a message having an identification of its corresponding application and a version number of the corresponding application. At operation 212, the message is posted to the infrastructure topic.

At operation 214, the application instance subscribes to a first topic of the message broker, if it has not done so already. At operation 216, one or more messages posted to the first topic are received by the application instance. At operation 218, it is determined if the application instance has been restarted. If so, then the method 200 loops back to operation 202. If not, then the method 200 continues to loop until the application instance is restarted.

In view of the disclosure above, various examples are set forth below. It should be noted that one or more features of an example, taken in isolation or combination, should be considered within the disclosure of this application.

Example 1. A system comprising:
at least one hardware processor; and
a computer-readable medium storing instructions that, when executed by the at least one hardware processor, cause the at least one hardware processor to perform operations comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

Example 2. The system of Example 1, wherein the generating and posting are performed when the first instance is deployed.

Example 3. The system of Examples 1 or 2, wherein the operations further comprise:
determining whether the first instance has been restarted; and
repeating the generating and posting in response to a determination that the first instance has been restarted.

Example 4. The system of any of Examples 1-3, wherein the operations further comprise, prior to the determining and causing, receiving one or more messages posted to the first topic, from the message broker.

Example 5. The system of any of Examples 1-4, wherein the application instance is a microservice.

Example 6. The system of any of Examples 1-5, wherein the causing disconnection includes causing the message broker to un-assign all message consumers in the consumer group from partitions of the first topic.

Example 7. The system of Example 6, wherein the partitions were assigned to the message consumers by a partitioning scheme.

Example 8. A method comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

Example 9. The method of Example 8, wherein the generating and posting are performed when the first instance is deployed.

Example 10. The method of Examples 8 or 9, further comprising:
determining whether the first instance has been restarted; and
repeating the generating and posting in response to a determination that the first instance has been restarted.

Example 11. The method of any of Examples 8-10, further comprising, prior to the determining and causing, receiving one or more messages posted to the first topic, from the message broker.

Example 12. The method of any of Examples 8-11, wherein the application instance is a microservice.

Example 13. The method of any of Examples 8-12, wherein the causing disconnection includes causing the message broker to un-assign all message consumers in the consumer group from partitions of the first topic.

Example 14. The method of claim Example 13, wherein the partitions were assigned to the message consumers by a partitioning scheme.

Example 15. A non-transitory machine-readable medium storing instructions which, when executed by one or more processors, cause the one or more processors to perform operations comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

Example 16. The non-transitory machine-readable medium of Example 15, wherein the generating and posting are performed when the first instance is deployed.

Example 17. The non-transitory machine-readable medium of Examples 15 or 16, wherein the operations further comprise:
determining whether the first instance has been restarted; and
repeating the generating and posting in response to a determination that the first instance has been restarted.

Example 18. The non-transitory machine-readable medium of any of Examples 15-17, wherein the operations further comprise, prior to the determining and causing, receiving one or more messages posted to the first topic, from the message broker.

Example 19. The non-transitory machine-readable medium of any of Examples 15-18, wherein the application instance is a microservice.

Example 20. The non-transitory machine-readable medium of any of Examples 15-19, wherein the causing disconnection includes causing the message broker to un-assign all message consumers in the consumer group from partitions of the first topic.

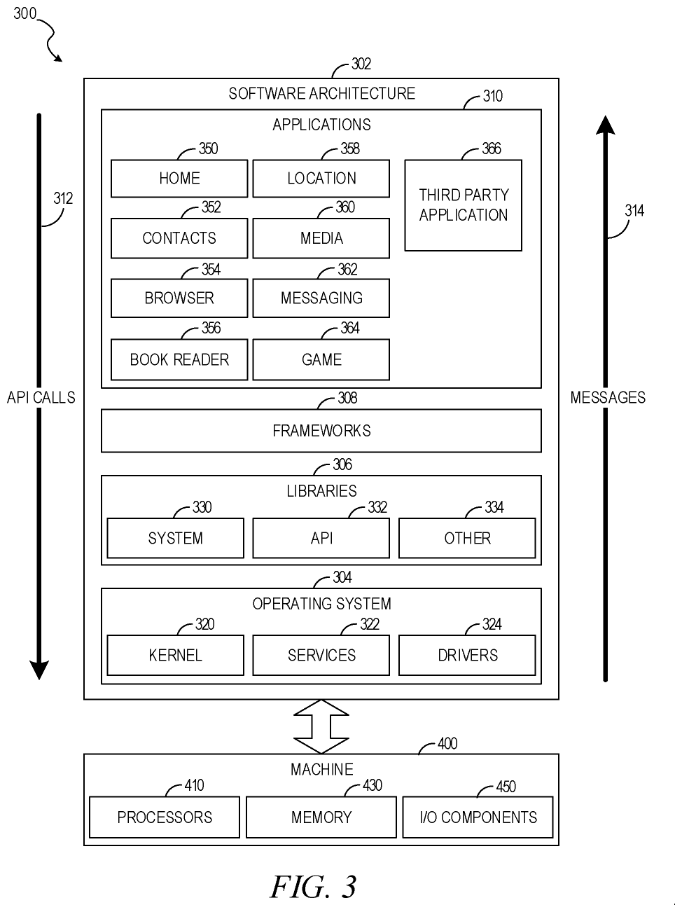

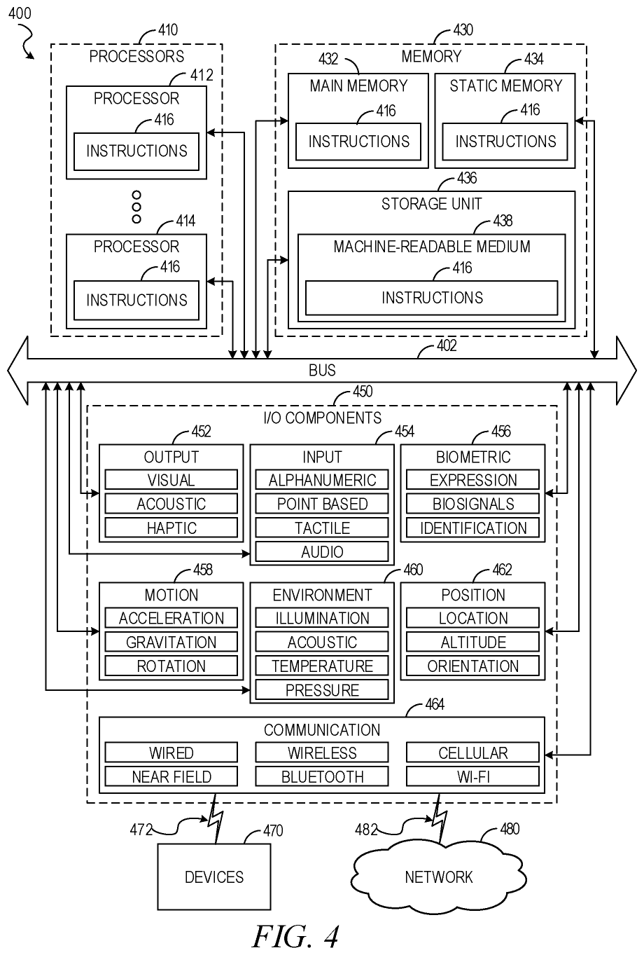

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionality. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various graphical user interface (GUI) functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the methods of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (i.e., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., Hypertext Transfer Protocol (HTTP)). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

2. The system of claim 1, wherein the generating and posting are performed when the first instance is deployed.

3. The system of claim 1, wherein the operations further comprise:
determining whether the first instance has been restarted; and
repeating the generating and posting in response to a determination that the first instance has been restarted.

4. The system of claim 1, wherein the operations further comprise, prior to the determining and causing, receiving one or more messages posted to the first topic, from the message broker.

5. The system of claim 1, wherein the application instance is a microservice.

6. The system of claim 1, wherein the causing disconnection includes causing the message broker to un-assign all message consumers in the consumer group from partitions of the first topic.

7. The system of claim 6, wherein the partitions were assigned to the message consumers by a partitioning scheme.

8. A method comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

9. The method of claim 8, wherein the generating and posting are performed when the first instance is deployed.

10. The method of claim 8, further comprising:
determining whether the first instance has been restarted; and
repeating the generating and posting in response to a determination that the first instance has been restarted.

11. The method of claim 8, further comprising, prior to the determining and causing, receiving one or more messages posted to the first topic, from the message broker.

12. The method of claim 8, wherein the application instance is a microservice.

13. The method of claim 8, wherein the causing disconnection includes causing the message broker to un-assign all message consumers in the consumer group from partitions of the first topic.

14. The method of claim 13, wherein the partitions were assigned to the message consumers by a partitioning scheme.

15. A non-transitory machine-readable medium storing instructions which, when executed by one or more processors, cause the one or more processors to perform operations comprising:
subscribing, from a first instance of an application, to a first topic of a message broker;
subscribing, from the first instance, to an infrastructure topic of the message broker;
generating, at the first instance, a message including an identification and version number of an application corresponding to the first instance;
posting the message to the infrastructure topic of the message broker;
receiving one or more messages, from other instances of the application, posted to the infrastructure topic;
determining that any of the one or more messages include a version number that is greater than the version number of the application corresponding to the first instance; and
in response to the determination, causing all message consumers in a consumer group of the application instance to disconnect from the first topic.

16. The non-transitory machine-readable medium of claim 15, wherein the generating and posting are performed when the first instance is deployed.

17. The non-transitory machine-readable medium of claim 15, wherein the operations further comprise:
determining whether the first instance has been restarted; and
repeating the generating and posting in response to a determination that the first instance has been restarted.

18. The non-transitory machine-readable medium of claim 15, wherein the operations further comprise, prior to the determining and causing, receiving one or more messages posted to the first topic, from the message broker.

19. The non-transitory machine-readable medium of claim 15, wherein the application instance is a microservice.

20. The non-transitory machine-readable medium of claim 15, wherein the causing disconnection includes causing the message broker to un-assign all message consumers in the consumer group from partitions of the first topic.
